(19) United States
(12) Patent Application Publication
(10) Pub. No.: US 2010/0215167 A1
(43) Pub. Date: Aug. 26, 2010

(54) Telephone-interface donation system

(76) Inventor: Victor Burneo, Gaithersburg, MD (US)

Correspondence Address: DODDS & ASSOCIATES, 1707 N STREET NW, WASHINGTON, DC, 20036, US

(21) Appl. No.: 12/655,869

(22) Filed: Jan. 8, 2010

Related U.S. Application Data
(60) Provisional application No. 61/208,162, filed on Feb. 20, 2009.

(51) Int. Cl. H04M 3/42

(52) U.S. Cl. 379/207.02

(57) ABSTRACT

A telephone-interface system which makes possible that subscribers of wired or wireless telephones receive through telephone voice messages (or text messages or other forms of data transmission) send by the respective telephone providers (or by charity or civic entities) an invitation to be part of a voluntary periodical donation program, using the fixed and mobile telephone terminals. Similarly donations oriented to help victims of huge natural disasters occurred in the USA or in foreign territories may be given through the disclosed system. Moreover, donations may be given for entities that make an exceptional labor on community interest or in favor of religious entities. Or, eventually, donations to some important sport clubs as a form to support these entertainment and civic activities. Or, eventually, donations may be given in favor of registered political parties or candidates of political parties, which could be a form to reinforce the democratic system through popular funding or in favor of political campaigns, if applicable; etc.

### PRIORITY

This application claims priority of the U.S. provisional application No. 61/208,162 filed on Feb. 20, 2009.

### FIELD OF THE INVENTION

This invention relates to the field of telecommunication. More specifically the invention relates to an art to donate funds to charities or other entities, via telecommunication system, specifically through wired and wireless telephones.

### BACKGROUND OF THE INVENTION

Due to the increasing need of funds for charitable and civic purposes, various ways for donating funds have been established. Most of them use interne addresses, usually computer terminal. Alternatively charitable organizations hire telemarketers and each telemarketer is looking for donations for specific entity. Customarily, these systems use credit cards as a payment method or the donors send checks via mail.

Accordingly, there is a need for a system to enable telephone operators' customers to contribute funds to charities or other entities of their choice without constant telemarketing calls.

### SUMMARY OF THE INVENTION

The invention according to this disclosure provides solution to the flaws of the currently existing systems for donating funds to charities or civic entities via telephone operators' services.

In order to achieve the fulfillment of the mission and objectives of charity and civic entities, this disclosure provides a method through which participating charity and civic entities can solicit wireless or wired service subscribers of telephone service providers (TPSs) to make contributions within the range of $1 to $99 per month, or of any other preferred range, that will be collected usually each month through the regular billing process of phone service provider.

In general, the present invention comprises a telephonic-interface donation system that will give broad possibilities for humanitarian or civic institutions to obtain the funds required to accomplish with their objectives. The system provides the donor an easy method to choose how much to donate, when to donate, and to whom to donate using exclusively land line or mobile telephones.

The system will avail a massive number of donations or contributions from telephone subscribers, mainly mobile telephone owners that can make periodical donations starting from small amounts, such as one dollar, through a simple procedure. Such massive volumes have been previously possible only through the internet, but in the case of this invention the volume of donators could be much higher than using the internet or telemarketing methods, due to the high number of mobile and land line phones in use. Accordingly, the method of this invention will enable donations from a large number of people that could not donate or would donate only sporadically with the present systems.

The system has the particular advantage that the donation can be made in a periodical sequence by donors registered by the telephone service provider.

According to the system of this disclosure, the Telephone Service Providers (TSPs) agree that their portfolio of subscribers of wired and mobile phones will be used by charities and other civic entities to contact such subscribers by a call and/or a message to ask for a donation which could be either periodical or one time donation.

The system of this disclosure has the particular characteristic that the TSPs will apply and process the required software to complete all the computer steps to record the donors that accept to participate in program, the amounts to be donated periodically by each donor, the total amount collected each month, the statistics of the donations collected and other applications that could be necessary to have a complete computer development. The art software enables a mechanism to include the amount donated into the telephone bill of the subscriber.

### BRIEF DESCRIPTION OF THE DRAWINGS

FIG. 1 shows a flowchart illustrating the overview of the donation method of the invention

FIG. 2 shows a flowchart illustrating the communication by the telephone service provider, (or by charity or civic entities) to its subscribers asking acceptance or rejection by the subscriber using the telephone terminal, to participate in a periodical donation program for the benefit of selected charity or civic entities.

FIG. 3 shows a flowchart illustrating the periodical calls (for example once a month or any other frequency) from the telephone provider asking the subscribers to make a selection of the entity to receive a donation by using the telephone terminal.

FIG. 4 shows a flowchart illustrating the telephone subscriber's selection through the telephone terminal of the entity to receive the periodical donation.

FIGS. 5A and 5B show a flowchart illustrating the telephone subscriber's selection through the telephone terminal, of the amount of money (e.g. US Dollars) to be donated and confirmation by subscriber to the telephone provider of that amount.

FIG. 6 shows a flowchart illustrating the subscriber's selection through the telephone terminal of other entities that could receive the periodical donation.

FIG. 7 shows a flowchart illustrating the procedure used by registered subscribers to cancel the participation on the donation program

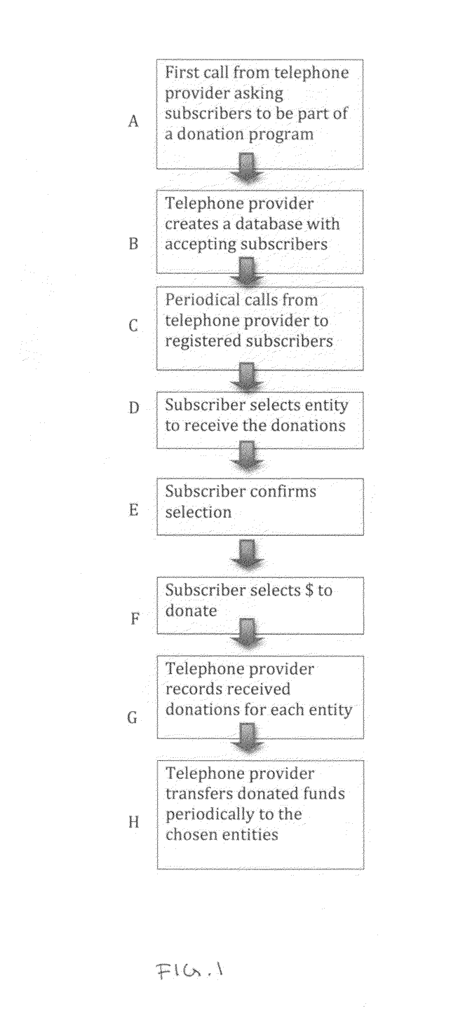

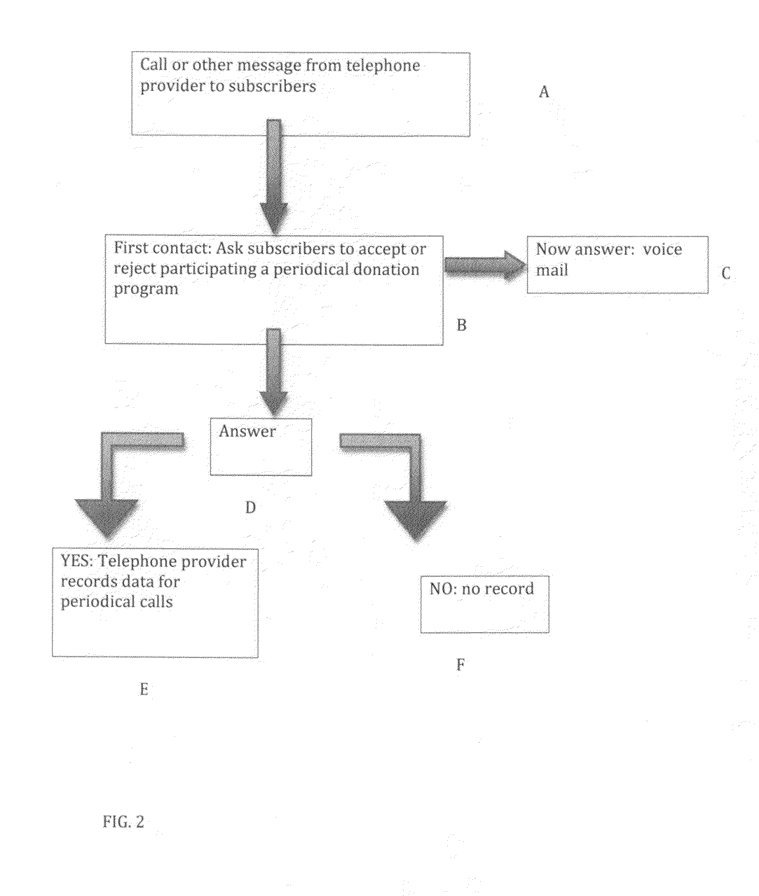

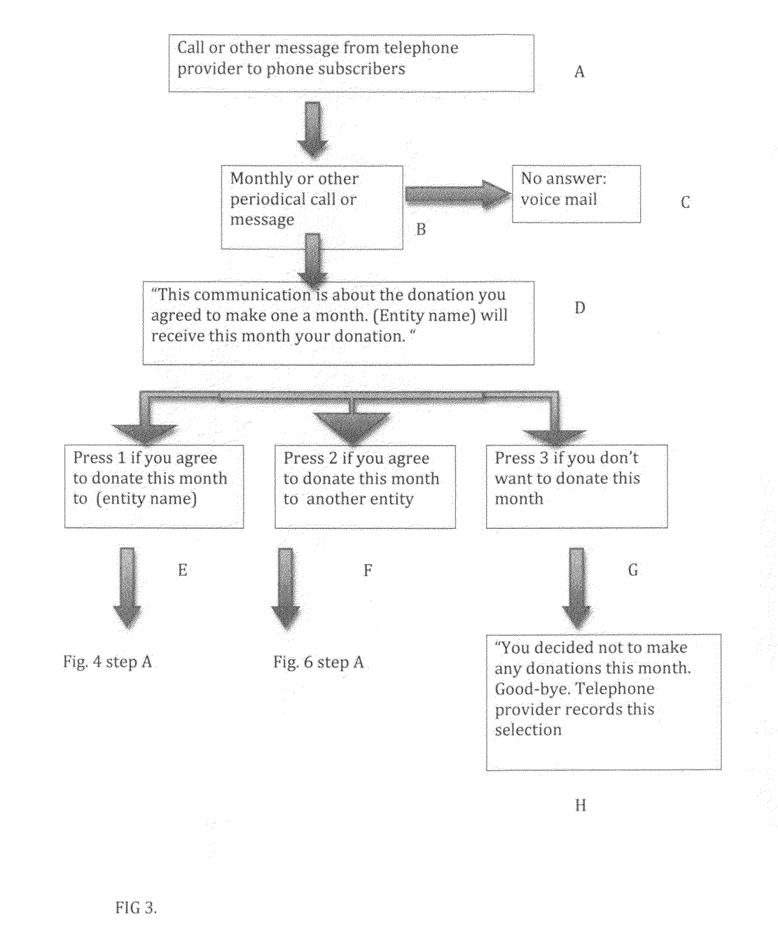

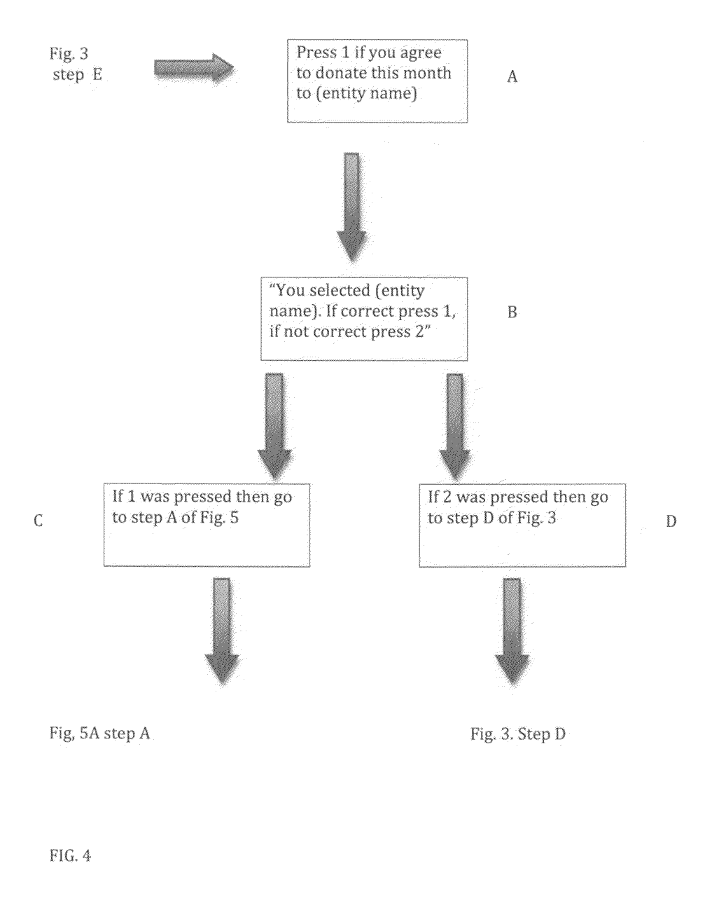

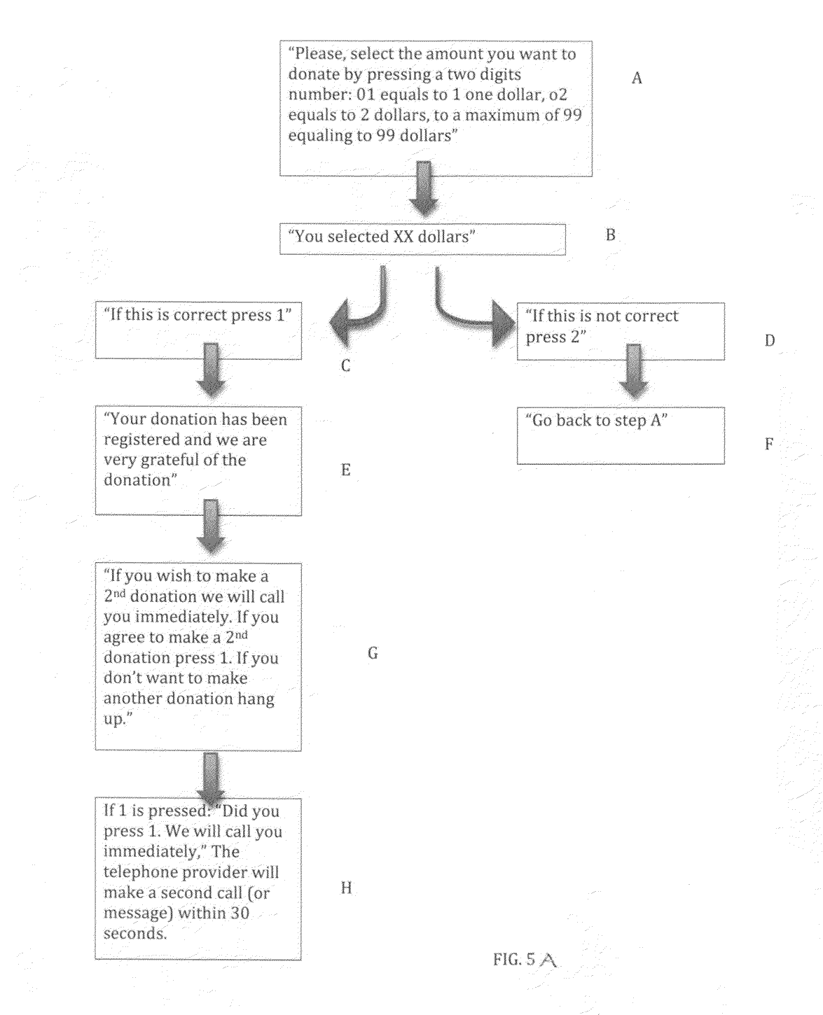

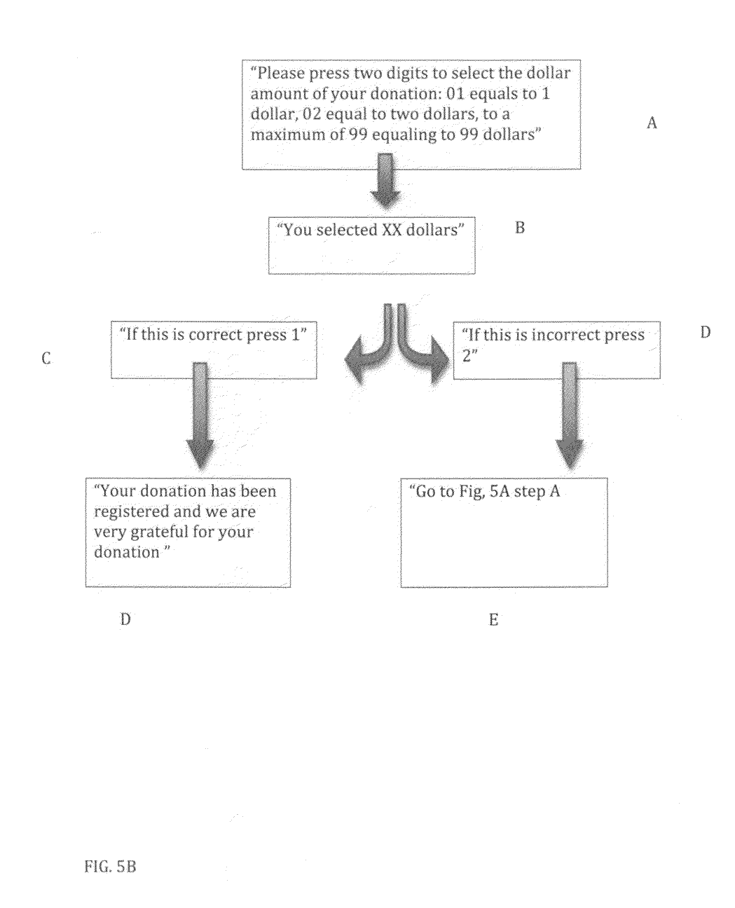

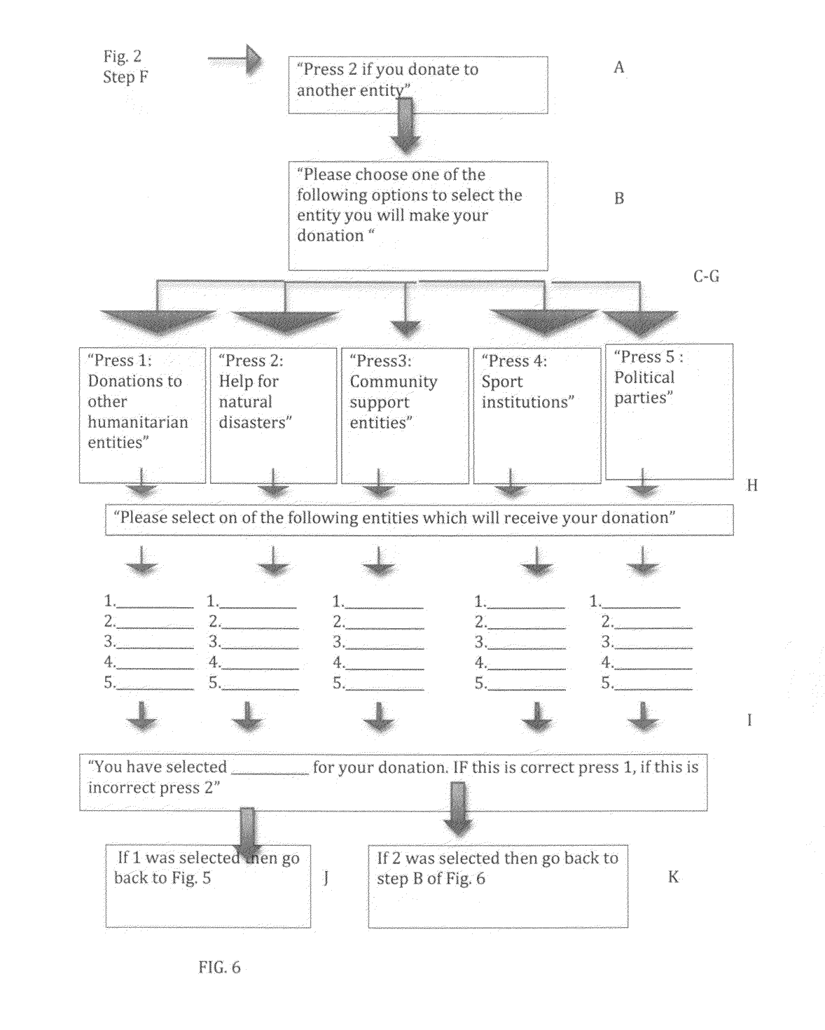

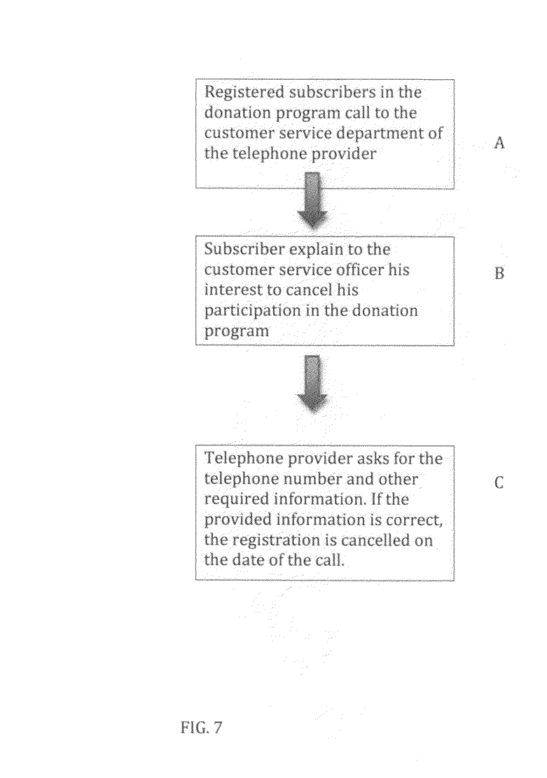

### DETAILED DESCRIPTION OF THE INVENTION

A description of the invention and detailed illustrative embodiments of the present invention are disclosed herein. However, physical communication systems, data format, sequence, text of messages and operating structures or beneficiary entities in accordance with the present invention may be embodied in a wide variety of forms and options, some of which may be quite different from those of the disclosed embodiment. Consequently, the specific structural and functional details disclosed herein are merely representative; yet in that regard, they are deemed to afford the best embodiments for purposes of disclosure and to provide a basis for the claims herein which define the scope of the present invention.

The invention according to this disclosure provides a telephone-interface system which makes possible that subscribers of wired or wireless telephones services receive through telephone voice messages (or text messages or other forms of data transmission) sent by the respective telephone providers an invitation to participate a voluntary periodical donation program, using the fixed and mobile telephone terminals.

According to this disclosure, the voice messages/text message or other forms of data transmission may also be sent by charity entities or other entities acting on behalf of the charity.

As used in this disclosure, the term ‘donation’ may also mean ‘contribution’. ‘Provider’ means the company operating the telephone line. ‘Subscriber’ means the subscriber of the telephone line.

The donations will be for the benefit of humanitarian entities or entities doing exceptional humanitarian, communitarian or solidarity services or, eventually, other beneficed civic categories as could be sport institutions or religious entities or for political campaigns, etc.

The subscribers will be asked through a telephone call (or by text message or other form of data transmission) from the respective telephone provider (or by charity or civic entities) to provide information accepting or rejecting participation in a voluntary periodical or one time donation program for the benefit of humanitarian entities or other categories of entities.

In accordance with such arrangements, recorded voice message (or text messages or other form of data transmission) sent by the telephone provider prompts all the subscribers to accept or reject participation in a program for donations for the benefit of some specific entities, in a periodical or alternatively one time basis.

The information of the telephone subscribers willing to participate the program will be stored by the telephone provider into a database to identify the accepting telephones. Later, for example once a month or at any desired frequency, telephone subscribers who accepted to participate the donation program will receive a voice message (or text message or other form of data transmission) from the telephone provider to make a selection of the entity or entities to receive a donation and the amount to be donated. The amount selected may be anything, but preferably in the United States amount may be between 1$ and $99 or other preferred range. According to this invention it would also be possible that the subscriber accepts to make a donation or contribution periodically by a specific amount, automatically and without the requirement of a periodical call. After the selection the selected amount will be included in the respective subscriber's monthly telephone bill.

Optionally, subscribers can accept to receive a 2^{nd} donation call for further donations.

The invention would also allow an option where after making a selection of beneficiary entities the subscriber calls to a specific telephone code (number or name or icon) to identify a beneficiary group and make a donation at any moment in favor of a selected entity.

The system may include leaving a voice message (or text message) in case the calls are not answered.

The system is configured to eliminate involuntary selection errors by the donors.

The telephone service provider will have a central computer system as part of the communication facility including software to process all the information of accepting subscribers, donors' selection of beneficiary entities and amounts donated. Such central computer system preferably includes storage means to store the data. The telephone service providers will support the central computer system and required software; the charity and civic entities may, however participate sending the text of messages and receiving from the telephone service providers the product of the periodical collected donations

According to a preferred embodiment the computer system periodically transfers the accumulated donations for the benefit of the beneficiary entities. The computer system may further process summaries of the donation information and provide the summaries to any defined destinations.

The system enables the telephone providers to store the cumulated donations received for the benefit of any one of the listed entities during a period of time and to credit the entity periodically accordingly. Each subscriber will have evidence of his/her donation in the telephone bill.

What is claimed is:

1. A method to collect donations from subscribers of a telephone provider, said method comprising the steps of:
a) providing a voice or text message by the telephone company or a charity or civic entity describing a donation program to all subscribers of the telephone provider, said message prompting the subscribers to accept or reject participation in the program;
b) creating a database of accepting subscribers;
c) providing to the accepting subscribers an option to select among beneficiary entities;
d) providing to the accepting subscribers an option to select any amount to be donated to selected beneficiary entity;
d) registering the selected amount in subscriber's periodic telephone bill;
e) reimbursing amounts collected to selected beneficiary entity; and
f) providing the accepting subscribers an option to cancel their acceptance.

2. The method of claim 1, wherein further step of asking acceptance of a second donation is included.

3. The method according to claim 1, wherein the provider processes information of the accepting subscribers, beneficiary entities and selected amount of donations with a central computer system including appropriate software required for this application, said central computer system and said software being supported by the provider.

4. The method according to claim 3, wherein the central computer system includes storage means for storing data.

5. The method according to claim 3, wherein the central computer system processes transfers of donations in favor of the beneficiary entities.

6. The method according to claim 3, wherein the central computer system processes summaries of donation information and distributes the information to defined destinations.
